(19) United States
(12) Patent Application Publication
(10) Pub. No.: US 2021/0390648 A1
(43) Pub. Date: Dec. 16, 2021

(54) METHOD FOR GENERATING ORDER RECEPTION PREDICTION MODEL, ORDER RECEPTION PREDICTION MODEL, ORDER RECEPTION PREDICTION DEVICE, ORDER RECEPTION PREDICTION METHOD, AND ORDER RECEPTION PREDICTION PROGRAM

(71) Applicant: NIPPON TELEGRAPH AND TELEPHONE CORPORATION, Tokyo (JP)

(72) Inventors: Tetsuya SHIODA, Musashino-shi, Tokyo (JP); Toshitaka MAKI, Musashino-shi, Tokyo (JP)

(73) Assignee: NIPPON TELEGRAPH AND TELEPHONE CORPORATION, Tokyo (JP)

(21) Appl. No.: 17/283,551

(22) PCT Filed: Nov. 8, 2019
(86) PCT No.: PCT/JP2019/043908

§ 371 Date: Apr. 8, 2021

(30) Foreign Application Priority Data
Nov. 27, 2018 (JP) 2018-221435

(51) Int. Cl. G06Q 50/18; G06N 20/00

(52) U.S. Cl. CPC G06Q 50/188; G06K 9/6256; G06N 20/00

(57) ABSTRACT

A generation unit (15a) generates, by learning, a contract-win prediction model (14a) by using, as training data, sales-related data for a past predetermined period N and information indicating the presence or absence of a contract won from a customer for a predetermined period M after the predetermined period N, the contract-win prediction model configured to receive an input of sales-related data of any customer for the predetermined period N, and to output a prediction result “contract winnable” or “contract not winnable” from the customer for a predetermined period M after the predetermined period N of the sales-related data. A prediction unit (15b) predicts “contract winnable” or “contract not winnable” from a customer for a future predetermined period M of a product of a predetermined product category with an input of sales-related data for the predetermined period N into the generated contract-win prediction model (14a).

### TECHNICAL FIELD

The present invention relates to a contract-win prediction model generation method, a contract-win prediction model, a contract-win prediction apparatus, a contract-win prediction method, and a contract-win prediction program.

### BACKGROUND ART

Sales representatives of business companies conduct sales activities for customers primarily based on their experiences and sense of business. To help sales representatives conduct sales activities with high efficiency, a technology for extracting customer information of best customers who have a high probability of purchasing products from customer information of the business company by using machine learning, for example, has been disclosed (see Non Patent Literature 1).

### CITATION LIST

### Non Patent Literature

Non Patent Literature 1: “Best Customer Analysis Service using AI”, [online], Toppan Printing Co., Ltd. [retrieved on Oct. 18, 2018], Internet <URL: https://solution.toppan.co.jp/cm/aitargeting/>

### SUMMARY OF THE INVENTION

### Technical Problem

However, conventional technologies are not always taken into account by sales representatives. In sales activities for the same customers, for example, the category of a specialized product of a sales representative, congeniality cultivated with past interactions with customers, and the like significantly affect sales results.

The present invention has been conceived in view of the above-described circumstances, and has an objective to enable sales activities to be conducted with high efficiency taking sales representatives and customers into consideration.

### Means for Solving the Problem

To solve the above-described problems and achieve the objective, a contract-win prediction model generation method according to the present invention is for acquiring sales-related data for a past predetermined period as training data, and generating, by using the training data, a contract-win prediction model which receives an input of sales-related data for a predetermined period, and outputs a contract-win probability with respect to a customer in a predetermined period after the aforementioned predetermined period.

In addition, the contract-win prediction model according to the present invention is a contract-win prediction model for functioning a computer to: learn a parameter of the contract-win prediction model by machine learning by using, as training data, sales-related data for a past predetermined period and information indicating the presence or absence of a contract won from a customer for a predetermined period after the aforementioned predetermined period, receive an input of sales-related data of any customer for a predetermined period, and output a prediction result “contract winnable” or “contract not winnable” from the customer for a predetermined period after the aforementioned predetermined period of the sales-related data.

### Effects of the Invention

According to the present invention, it is possible to enable sales activities to be conducted with high efficiency in consideration of sales representatives and customers.

### BRIEF DESCRIPTION OF DRAWINGS

FIG. 1 is a schematic diagram illustrating an overall configuration of a contract-win prediction apparatus according to the present embodiment.

FIG. 2 is a diagram illustrating a data configuration of customer data.

FIG. 3 is a diagram illustrating a data configuration of contract-win data.

FIG. 4 is a diagram illustrating a data configuration of daily report data.

FIG. 5 is an explanatory diagram for describing a one-hot vector conversion.

FIG. 6 is a diagram for describing multi-lavel classification.

FIG. 7 is a diagram illustrating a customer visit list.

FIG. 8 is a flowchart showing a contract-win prediction processing procedure by a generation unit.

FIG. 9 is a flowchart showing a contract-win prediction processing procedure by a prediction unit.

FIG. 10 is a diagram illustrating an example of a computer that executes a contract-win prediction program.

### DESCRIPTION OF EMBODIMENTS

Hereinafter, an embodiment of the present invention will be described in detail with reference to the drawings. Note that the present invention is not limited by the embodiment. Further, in description of the drawings, the same parts are denoted by the same reference signs.

Contract-Win Prediction Model

A contract-win prediction model of the present embodiment is assumed to be utilized as a program module that is a part of artificial intelligence software. The contract-win prediction model of the present embodiment is a learned model in which parameters are learned by machine learning using, as training data, sales-related data in a past predetermined period N and information indicating the presence or absence of a contract won from a customer in a predetermined period M after the predetermined period N.

The contract-win prediction model is used in a computer with a computer CPU and a memory for computers. For example, as will be described below, the CPU of the computer which is a contract-win prediction apparatus operates to perform an arithmetic operation based on the parameters and a response function, or the like from the sales-related data for any input customer for a predetermined period N in accordance with instructions from the contract-win prediction model stored in the memory and to output a prediction result “contract winnable” or “contract not winnable” from the customer for a predetermined period M after the predetermined period N of the sales-related data.

Furthermore, as will be described below, the contract-win prediction apparatus acquires, as training data, the sales-related data for the past predetermined period N, and generates, by using the training data, a contract-win prediction model which receives an input of the sales-related data for the predetermined period N by using the training data, and outputs a contract-win probability of the customer for the predetermined period M after the predetermined period N.

Configuration of Contract-Win Prediction Apparatus

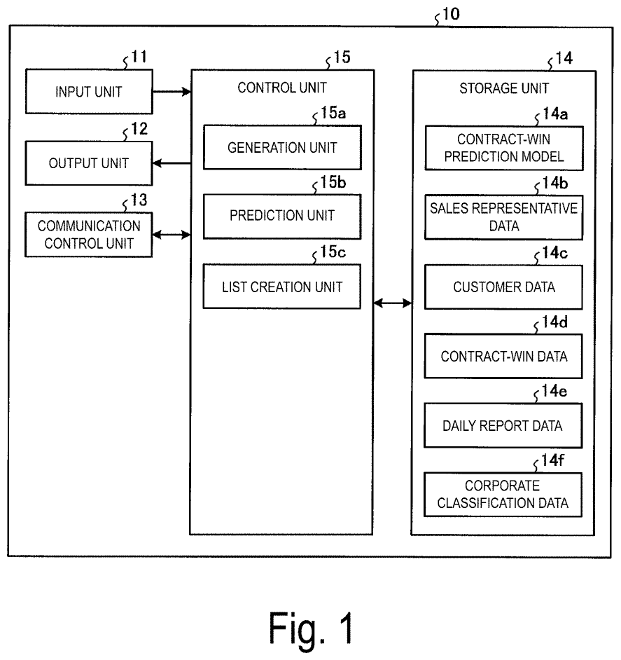

FIG. 1 is a schematic diagram illustrating an overall configuration of a contract-win prediction apparatus according to the present embodiment. As illustrated in FIG. 1, the contract-win prediction apparatus 10 is realized by a general-purpose computer such as a personal computer and includes an input unit 11, an output unit 12, a communication control unit 13, a storage unit 14, and a control unit 15.

The input unit 11 is realized by using an input device such as a keyboard or a mouse, and inputs various kinds of instruction information for starting processing to the control unit 15 or the like in response to an operation input by an operator. The output unit 12 is realized by a display apparatus such as a liquid crystal display or a printing apparatus such as a printer.

The communication control unit 13 is realized by a network interface card (NIC), or the like, and controls communication between the control unit 15 and an external apparatus via an electric communication line such as a local area network (LAN) or the Internet. For example, the communication control unit 13 controls communication of the control unit 15 with a management apparatus or the like that manages sales-related data used in a contract-win prediction processing which will be described below.

The storage unit 14 is realized by a storage device such as a semiconductor memory element like a random access memory (RAM) or a flash memory, a hard disk, an optical disc, or the like. Note that the storage unit 14 may be configured to communicate with the control unit 15 via the communication control unit 13.

In the present embodiment, the storage unit 14 stores a contract-win prediction model 14a generated in the contract-win prediction processing which will be described below. In addition, the storage unit 14 stores sales-related data input via the input unit 11 or the communication control unit 13. The sales-related data includes sales representative data 14b, customer data 14c, contract-win data 14d, daily report data 14e, corporate classification data 14f, and the like.

The sales representative data 14b is information indicating personal information and business results of sales activities of sales representatives. In the present embodiment, the sales representative data 14b includes a skill rank assigned linearly in accordance with the average of gross profit from sales of the sales representative every 6 months.

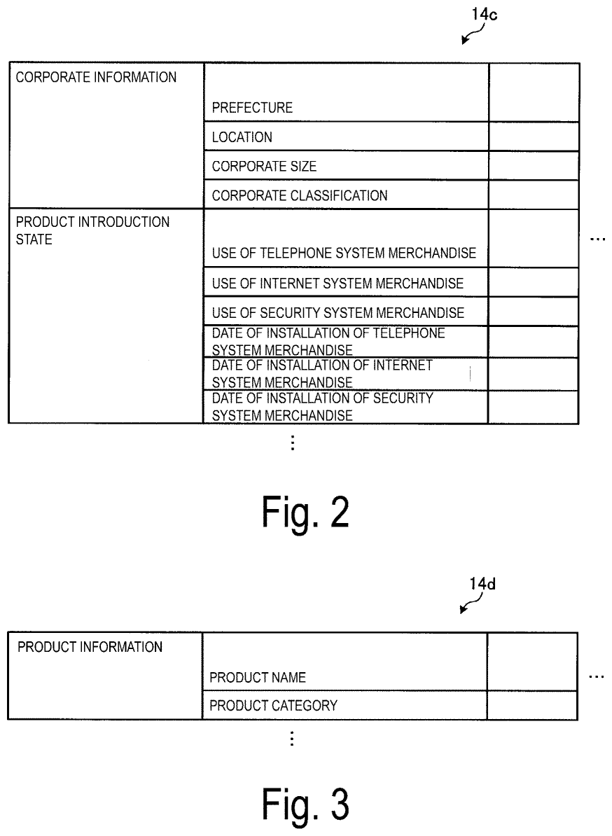

The customer data 14c is information indicating corporate information of customers who were the targets of business activities and contributed to business results in the past, a product introduction state of products purchased by the customers, and the like. Here, FIG. 2 is a diagram illustrating a data configuration of the customer data 14c. As illustrated in FIG. 2, for example, the customer data 14c includes, as corporate information of a customer, the name of a prefecture, location, a corporate size represented as SOHO, a small size, a medium size, or the like, corporate classification represented as retail, construction, or the like, and so on.

In addition, the customer data 14c includes, for example, as a product introduction state of the customer, use of telephone system merchandise, use of Internet system merchandise, use of security system merchandise, the date of installation of telephone system merchandise, the date of installation of Internet system merchandise, the date of installation of security system merchandise, and the like.

The contract-win data 14d is product information and contract-win information of a product contracted with a customer by a sales representative, and the like. Here, FIG. 3 is a diagram illustrating a data configuration of the contract-win data 14d. As illustrated in FIG. 3, for example, the contract-win data 14d includes, as product information, a product name, a product category such as telephone system merchandise or Internet system merchandise, or the like.

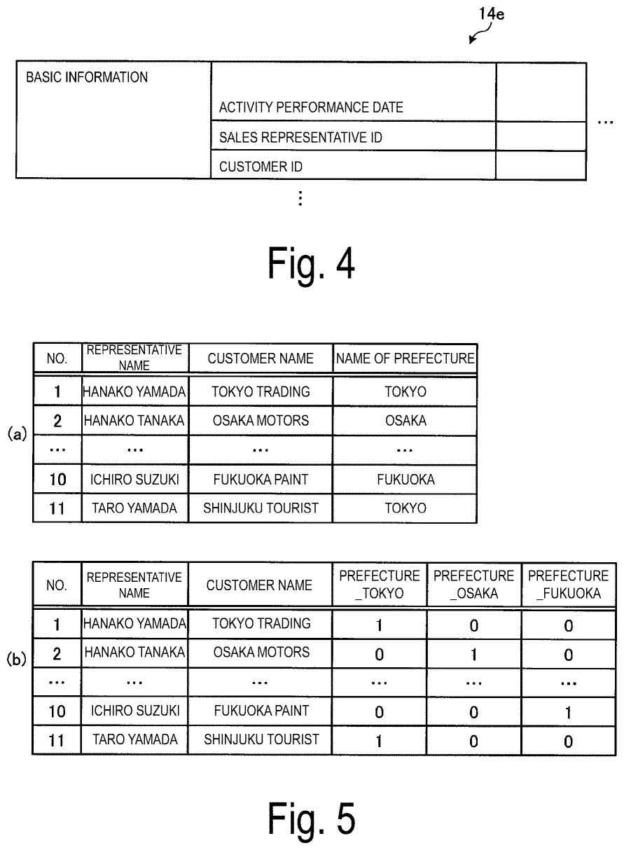

The daily report data 14e is information representing an activity record on sales activities conducted by the sales representative for customers, and is input by the sales representative as a daily report. Here, FIG. 4 is a diagram illustrating a data configuration of the daily report data 14e. As illustrated in FIG. 4, for example, the daily report data 14e includes, as basic information, an activity performance date, a sales representative ID, a customer ID, and the like. Note that, as the number of items input in the daily report becomes greater, the sales representative is evaluated to be more earnest.

The corporate classification data 14f is information indicating mapping between the corporate classification included in the customer data 14c and the corporate classification defined by the Tokyo Stock Exchange. The corporate classification included in the customer data 14c is detailed corporate classification according to the classification levels adopted by Townpages. On the other hand, in the contract-win prediction processing which will be described below, the corporate classification used by the Tokyo Stock Exchange is adopted to ensure suitable classification levels so that the number of customers included in each corporate classification is not excessively small. Thus, in the contract-win prediction processing which will be described below, the corporate classification data 14f is referred to, and the corporate classification of the customer data 14c is replaced with the corporate classification of the Tokyo Stock Exchange from the corporate classification adopted in Townpages.

The control unit 15 is realized by using a central processing unit (CPU), and executes a processing program stored in a memory. Thus, the control unit 15 functions as a generation unit 15a, a prediction unit 15b, and a list creation unit 15c as illustrated in FIG. 1.

Note that the above-described functional units may be implemented respectively, or a part of the functional units may be implemented in different hardware. For example, the generation unit 15a may be implemented in different hardware from the prediction unit 15b and the list creation unit 15c. That is, although a case in which the contract-win prediction apparatus performs both the generation of the contract-win prediction model 14a and prediction using the contract-win prediction model 14a has been described in the present embodiment, the generation of the contract-win prediction model 14a and the prediction using the contract-win prediction model 14a may be performed by separate apparatuses.

The generation unit 15a uses, as training data, the sales-related data for the past predetermined period N and information indicating the presence or absence of a contract won from a customer for the predetermined period M after the predetermined period N, and generates, by learning the contract-win prediction model 14a that receives an input of the sales-related data of any customer for the predetermined period N, and outputs a prediction result “contract winnable” or “contract not winnable” from the customer for the predetermined period M after the predetermined period N of the sales-related data.

Specifically, in the present embodiment, it is assumed that N=18 months and M=6 months. However, M and N may have any values. In addition, the predetermined period N and the predetermined period M may be continuous or intermittent. Furthermore, an intermission period in a case in which the predetermined period N and the predetermined period M are intermittent may have any value.

Furthermore, the generation unit 15a uses the sales representative data 14b, the customer data 14c, the contract-win data 14d, the daily report data 14e, or the corporate classification data 14f as the sales-related data.

Furthermore, the generation unit 15a performs pre-processing to extract feature values of the sales-related data. At this time, the generation unit 15a extracts, as feature values, feature values of sales representatives, feature values of customers, and feature values of business types.

For example, the generation unit 15a uses the sales representative data 14b, the contract-win data 14d, and the daily report data 14e as feature values of a sales representative to extract feature values representing a sales skill level, past sales performance, earnestness, and employment status of the sales representative.

Specifically, the sales skill level of the sales representative is assumed to be represented by a numerical value of the threshold (average gross profit from sales) corresponding to each skill rank of the sales representative data 14b. The reason for this is that, if the skill rank is represented by a character string such as D to SA, it is hard to express numerical continuity. In addition, an average value of a past predetermined period T (term) is applied to allow a sales representative who has continuously acquired high evaluation to be evaluated highly. This may mitigate the effect of an instance in which, for example, when a contract employee needs to acquire a predetermined value or higher in the skill rank to be promoted to a full-time employee or the like, the contract employee is likely to hold a high position in the skill rank only for the last 6 months intentionally. Note that, assuming that 6 months are one term, T is any value equal to or greater than 1.

In the present embodiment, assuming that T=4 terms (past 2 years), a business skill level is calculated using the following formula (1). Where sᵢ is a business skill level i terms ago.

$$\begin{matrix}[ Math . 1 ] & \\ \frac{1}{T} {\sum }_{i = 1}^{T} {s}_{i} & ( 1 )\end{matrix}$$

Moreover, past sales performance of each sales representative is assumed to be represented by an amount of won contracts for each product category, the absolute value of the number of won contracts, and the proportion of the number of won contracts to all product categories of the sales representative. Specifically, the generation unit 15a first counts the contract-win data 14d for each sales representative and for each product category. Next, the generation unit 15a calculates, as an amount of sales for each product category, the sum of the amount of won contracts of the product category for a predetermined period N. Furthermore, the generation unit 15a counts the total number of won contracts of each product category for the predetermined period N as the absolute value of the number of won contracts of the product category. Furthermore, the generation unit 15a calculates the proportion of the number of won contracts of each product category by dividing the absolute value of the number of won contracts of the product category by the absolute value of the number of won contracts of all product categories.

The excellency of the sales representative can be represented by the amount of won contracts and the absolute value of the number of won contracts calculated as described above. In addition, the proportion of the number of won contracts represents the specialized product category of the sales representative.

Furthermore, the earnestness of the sales representative is assumed to be represented by the average value of the number of characters input by the sales representative into a consultation memo included in the daily report data 14e. Because a conversation with a customer, a progress status of a case, or the like is input into such a consultation memo in a free format, a sales representative evaluated to be more earnest is thought to input more characters into a memo. Thus, for example, if a total number of daily reports input by a sales representative for a certain period T RT and the number of characters input to a consultation memo of an i-th daily report is |sᵢ|, the earnestness of the sales representative is expressed using formula (2) below. In the present embodiment, it is assumed that the certain period T=360 days.

$$\begin{matrix}[ Math . 2 ] & \\ \frac{1}{{R}_{T}} {\sum }_{i = 1}^{{R}_{T}} \vert {S}_{i} \vert & ( 2 )\end{matrix}$$

An employment status of a sales representative is an employment status included in the sales representative data 14b, and is represented as any of full-time employee or contract employee in the present embodiment.

Furthermore, the generation unit 15a uses, as feature values of a customer, the customer data 14c, the contract-win data 14d, and the corporate classification data 14f to extract feature values representing a purchase record, corporate classification, basic information, and a product introduction state of the customer.

A purchase record of a customer is assumed to be represented by an amount of purchase of the customer for each product category, the absolute value of the number of purchases, and a proportion of the number of purchases to all categories. Specifically, the generation unit 15a first counts the contract-win data 14d for each customer and each product category. Next, the generation unit 15a calculates, as an amount of purchase for each product category, the sum of the amount of won contracts of the product category for the predetermined period N. Furthermore, the generation unit 15a counts, as the absolute value of the number of purchases for each product category, the total number of won contracts of the product category for the predetermined period N. Furthermore, the generation unit 15a calculates the proportion of the number of purchases to each product category by dividing the absolute value of the number of won contracts of the product category by the absolute value of the number of won contracts of all product categories.

The ease of sales for the customer and a size and budget of the business of the customer are represented by the amount of purchase and the absolute value of the number of purchases calculated as described above. In addition, the product category in which the customer is interested is represented by the proportion of the number of purchases.

With respect to corporate classification of customers, the corporate classification of the customer data 14c is assumed to be replaced with the corporate classification of the Tokyo Stock Exchange. The generation unit 15a refers to the corporate classification data 14f to identify the corporate classification of the customer.

Basic information of the customer is assumed to be represented by the name of a prefecture, the location, and the corporate size included in the customer data 14c. The generation unit 15a extracts, from the customer data 14c, the name of the prefecture, the location, and the corporate size of the customer.

The product introduction state of the customer is assumed to be represented by a product introduction state of the customer included in the customer data 14c. The generation unit 15a extracts, for example, as a product introduction state of the customer, use of telephone system merchandise, use of Internet system merchandise, use of security system merchandise, the date of installation of the telephone system merchandise, the date of installation of the Internet system merchandise, and the date of installation of the security system merchandise.

Furthermore, the generation unit 15a uses the contract-win data 14d and the corporate classification data 14f to extract feature values representing a purchase record of the business type as feature values of a business type.

The purchase record of the business type is assumed to be represented by an amount of purchase of each business type for each product category, the absolute value of the number of purchases, and a proportion of the number of purchases to all categories. Specifically, the generation unit 15a first counts the contract-win data 14d for each corporate classification of the corporate classification data 14f and each product category. Next, the generation unit 15a calculates, as an amount of purchase for each product category, the sum of the amount of won contracts of the product category for the predetermined period N. Furthermore, the generation unit 15a counts, as the absolute value of the number of purchases for each product category, the total number of won contracts of the product category for the predetermined period N. Furthermore, the generation unit 15a calculates the proportion of the number of purchases to each product category by dividing the absolute value of the number of won contracts of the product category by the absolute value of the number of won contracts of all product categories.

The ease of sales in the business type and a size of the industry are represented by the amount of purchase and the absolute value of the number of purchases calculated as described above. In addition, the product category gaining attention from the industry is represented by the proportion of the number of purchases.

Then, the generation unit 15a uses the extracted feature values of the sales representative, feature values of the customer, and feature values of the business type to create feature value data X. Specifically, the generation unit 15a aggregates the feature values of the sales representative, the feature values of the customer, and the feature values of the business type to create tabular data such as a CSV file. In each row of the tabular data, a feature value of each customer of each sales representative is stored.

For example, the generation unit 15a obtains, for each sales representative, a list of customers of the sales representative along with various feature values. In addition, the generation unit 15a assigns, to each customer, a corporate classification defined by the Tokyo Stock Exchange included in the corporate classification data 14f Then, the generation unit 15a creates, for each sales representative, a tabular data in which various feature values for each customer assigned with the corporate classification are included in one row, and sets the data as feature value data X.

Next, the generation unit 15a uses sales-related data for a predetermined period M after the predetermined period N, which is a period for which sales-related data of the extraction source of the feature value data X was created, to append a contract-win flag indicating the presence or absence of a contract won from the customer in the predetermined period M as a training label y. The information indicating the presence or absence of a contract is information included in the sales-related data.

Specifically, the generation unit 15a appends the contract-win flag to the record of each row of the feature value data X, i.e., each customer of each sales representative, with reference to the contract-win data 14d for the predetermined period M. That is, the generation unit 15a sets the contract-win flag to true if the sales representative has won a contract of any product category from the customer, and sets the contract-win flag to false if the sales representative has not won a contract.

In this way, the generation unit 15a creates training data (X, y) by appending the training label y to the feature value data X.

Furthermore, the generation unit 15a converts the extracted feature values into one-hot vectors for standardization as pre-processing.

Here, a machine learning algorithm configured to be mathematical processing is not capable of processing category feature values represented by multiple textual options, such as an employment status, the name of the prefecture, and the like, to textual information as is. For example, there are two textual options for the employment status, including “full-time employee” and “contract employee”. In addition, there are a maximum of 47 textual options for the name of the prefecture, including “Tokyo”, “Osaka”, “Fukuoka”, and the like. Thus, the generation unit 15a quantifies and handles such a category feature value by converting the value into a one-hot vector represented by “0” or “1”.

For example, FIG. 5 is an explanatory diagram for describing a one-hot vector conversion. In the example illustrated in FIG. 5, the names of prefectures shown in FIG. 5(a) are deployed in the column direction by the number of options in FIG. 5(b). For example, the names of prefectures in FIG. 5(a) (in this example, the number of options is three) including Prefecture_Tokyo, Prefecture_Osaka, and Prefecture_Fukuoka are deployed as three items in FIG. 5(b).

In this case, the one-hot vector can be represented by 1 if the name of a prefecture is applicable, or by 0 if the name of a prefecture is not applicable. For example, the name of the prefecture “Tokyo” in FIG. 5(a) is quantified as a numerical value such that “1” is for Prefecture_Tokyo, “0” is for Prefecture_Osaka, and “0” is for Prefecture_Fukuoka in FIG. 5(b).

In this manner, the generation unit 15a performs the one-hot vector conversion for items that are the category feature values of the feature value data X. For example, the generation unit 15a performs the one-hot vector conversion for the names of the prefectures among the feature values of the customer. Similarly, the generation unit 15a performs the one-hot vector conversion on the location, the corporate size, the corporate classification, the product introduction state (use of telephone system merchandise, use of Internet system merchandise, or use of security system merchandise), and the like among the feature values of the customer. Furthermore, the generation unit 15a performs the one-hot vector conversion on the employment status among the feature values of the sales representative.

In addition, in the case in which variables having different ranges, such as heights and weights, are learned by machine learning, the influence of a variable having an absolute value in a higher range of is large, and thus the accuracy of learning is reduced. For example, weights that have smaller absolute values than heights have a lower contribution rate in learning.

Thus, the generation unit 15a performs standardization, which is a scale conversion of a variable according to a certain criterion, on each item of the feature value data X. For example, the generation unit 15a standardizes each item of the feature value data X such that the item falls within a range with the minimum value of 0 and the maximum value of 1.

Note that the standardization method is not particularly limited. For example, the scale conversion of the variables may be performed so that the average is 0 and the variance is 1. Alternatively, the scale conversion of the variables may be performed so that the item falls within the range with a specified minimum value and maximum value. Alternatively, the scale conversion of the variables may be performed with reference to quartiles.

In subsequent processing, the generation unit 15a uses feature value data X′ obtained by performing the one-hot vector conversion and standardization on the feature value data X and the training label y to process (X′, y) as training data. However, in the following description, (X′, y) may be denoted by (X, y).

Next, the generation unit 15a generates, by learning, the contract-win prediction model 14a for outputting a prediction result “contract winnable” or “contract not winnable” from a customer for the predetermined period M after the predetermined period N of the input sales-related data.

Here, the contract-win prediction model 14a is a learned model for which parameters are learned by machine learning by using the sales-related data of the past predetermined period N and the information indicating the presence or absence of a contract won from a customer for the predetermined period M after the predetermined period N as training data.

Specifically, the generation unit 15a learns the contract-win prediction model 14a using the feature value data X extracted from the sales-related data of the above-described predetermined period N and the training label y as training data.

In the present embodiment, the contract-win prediction model 14a is assumed to have a parameter to be learned according to a logistic regression algorithm represented by the following formula (3). In the present embodiment, the contract-win prediction model 14a performs a binary classification task of “contract winnable” or “contract not winnable”. However, the applied algorithm is not particularly limited, and an algorithm that enables classification learning is applied. For example, random forest, deep neural networks, and the like are possible.

$$\begin{matrix}[ Math . 3 ] & \\ h ( {p}_{i} ) = ln ( \frac{{p}_{i}}{1 - {p}_{i}} ) = {\sum }_{i}^{N} {w}_{i} {x}_{i} + b & ( 3 )\end{matrix}$$

Here, wᵢ represents the weight of a linear model and b represents the bias term. For the N-order linear algorithm represented by formula (3) described above, the identification boundary of the binary classification is an N−1 dimensional hyperplane. Furthermore, by substituting h(pᵢ) of formula (3) described above into the standard sigmoidal function, the output is converted to a probability pᵢ, as shown in the following formula (4).

$$\begin{matrix}[ Math . 4 ] & \\ \begin{matrix}{p}_{i} = \frac{1}{1 + h ( {p}_{i} )} \\ = \frac{1}{1 + ln ( \frac{{p}_{i}}{1 - {p}_{i}} )} \\ = \frac{1}{1 + {\sum }_{i}^{N} {w}_{i} {x}_{i} + b}\end{matrix} & ( 4 )\end{matrix}$$

The generation unit 15a gives the training data (X′, y) as an input to formula (4) above, and learns wᵢ and b which are parameters of the contract-win prediction model 14a, so that the feature value data X′ is classified according to the training label y. Here, xᵢ is the i-th item of the feature value data X′ (explanatory variable), and pᵢ is a contract-win probability of a product of any product category from a customer with respect to the sales representative. In this way, the generation unit 15a determines the parameters wᵢ and b by learning.

In addition, the probability pᵢ output in formula (4) above is classified “contract winnable” or “contract not winnable” with a predetermined threshold. For example, in a case in which the threshold is 0.5, “contract winnable” is output if the probability pᵢ is higher than or equal to 0.5, and “contract not winnable” is output if the probability pᵢ is less than 0.5.

Note that, in this case, “contract winnable” is output even in a case in which the probability is near 0.5 and the contract win is unclear. On the other hand, “contract winnable” is output only when the probability of the contract win is high if the threshold is close to 1. Thus, this method is effective only in a case in which it is desired to output “contract winnable” only for a customer from whom the contract is likely to be successfully won among many customers. In this way, any value can be set for the threshold as a parameter of the contract-win prediction model 14a.

In this manner, the generation unit 15a generates the contract-win prediction model 14a by determining the parameters wᵢ and b and the threshold. The generation unit 15a causes the storage unit 14 to store the generated contract-win prediction model 14a.

Note that the generation unit 15a can generate the contract-win prediction model 14a such that a product category is specified and a prediction result “contract winnable” or “contract not winnable” is output using a multi-label classification algorithm. Here, a multi-label classification task is a task of classification with each label without allowing exception when a plurality of labels are assigned to certain data. An example of the task is, for example, a case in which a plurality of hashtags appended to a document posted on an SNS are predicted.

The above-described training label y is a contract-win flag indicating whether a contract on a product of any product category has been won without distinguishing product categories. With respect to this, the generation unit 15a may generate the contract-win prediction model 14a such that a product category is specified by appending a training label y_multi indicating whether a contract on a product has been won to each product category and a prediction result “contract winnable” or “contract not winnable” is output.

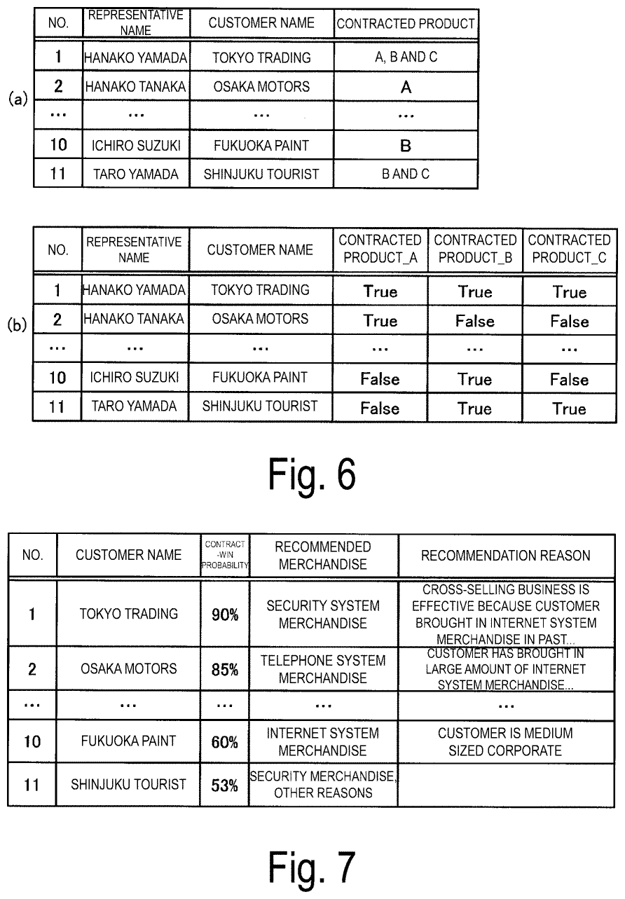

FIG. 6 is a diagram for describing multi-lavel classification. FIG. 6 illustrates a case in which the number of product categories of contracted products are three including A, B, and C. For example, there may be a case in which there are a plurality of product categories of contracted products when the contract-win flag of the above-described training label y “True” is set as illustrated in FIG. 6(a). Thus, the generation unit 15a deploys the contract-win flags in the column direction by the number of product categories of the contracted product as illustrated in FIG. 6(b). In the example illustrated in FIG. 6(b), the contract-win flags for three product categories including a contracted product_A, a contracted product_B, and a contracted product_C are deployed.

Then, the generation unit 15a appends each contract-win flag for the product category to the record of each row of the feature value data X, i.e., each customer of each sales representative, with reference to the contract-win data 14d of the predetermined period M. That is, if the sales representative has won the contract on the product of the product category from the customer, the generation unit 15a sets the contract-win flag of the product category to “true”, and if not, the generation unit 15a sets the contract-win flag of the product category to “false”. In this way, the generation unit 15a appends the training label y_multi indicating whether a contract on the product of each product category has been won to the record of each row of the feature value data X.

The generation unit 15a prepares classification models only by the number of labels to learn the multi-label classification, and performs learning in a question format called one-virsus-rest to indicate a corresponding label. For example, with respect to prediction results “contract winnable” and “contract not winnable” on Internet system merchandise, the generation unit 15a generates the contract-win prediction model 14a for the Internet system merchandise in a procedure similar to that as described above. The contract-win prediction model 14a, the contract-win prediction apparatus 10, for example, specifies Internet system merchandise and outputs a prediction result “contract winnable” or “contract not winnable”.

FIG. 1 is described again. The prediction unit 15b predicts “contract winnable” or “contract not winnable” from a customer for a future predetermined period M by inputting sales-related data for the predetermined period N into the generated contract-win prediction model 14a.

Specifically, first, the prediction unit 15b acquires, from the storage unit 14, the sales-related data for the predetermined period N different from the sales-related data used as the training data. For example, the prediction unit 15b acquires the sales representative data 14b, the customer data 14c, the contract-win data 14d, the daily report data 14e, or the corporate classification data 14f as sales-related data.

Furthermore, the prediction unit 15b performs pre-processing to extract feature values of the sales-related data, similarly to the above-described generation unit 15a. At this time, the prediction unit 15b extracts feature values of sales representatives, feature values of customers, and feature values of business types as feature values.

Then, the prediction unit 15b uses the extracted feature values of the sales representatives, feature values of the customers, and feature values of the business types to create feature value data X_test, similarly to the generation unit 15a. Specifically, the prediction unit 15b aggregates the feature values of the sales representatives, the feature values of the customers, and the feature values of the business types, creates tabular data with a feature value for each customer of each sales representative in one row, and sets the data as the feature value data X_test.

In addition, the prediction unit 15b performs a one-hot vector conversion on the feature value data X_test for standardization, and sets the result as feature value data X′_test, similarly to the generation unit 15a,

Then, the prediction unit 15b inputs the feature value data X′_test into the contract-win prediction model 14a stored in the storage unit 14, and obtains a contract-win probability of a product of any product category of a customer with respect to a sales representative. In addition, the prediction unit 15b obtains a prediction result y_test of “contract winnable” or “contract not winnable” of a product of any product category from the customer for the future predetermined period M with respect to the sales representative for which the contract-win probability is classified at a predetermined threshold.

Note that the prediction unit 15b can use a multi-label classification algorithm to specify the product category of a product to recommend to customers. In this case, the prediction unit 15b uses the contract-win prediction model 14a for each product category, the model generated by the generation unit 15a to specify the product category and output a prediction result “contract winnable” or “contract not winnable” using the multi-label classification algorithm. Thus, the prediction unit 15b obtains a prediction result “contract winnable” or “contract not winnable” from the customer for the product of the predetermined product category. Thus, the contract-win prediction apparatus 10 can present a customer who is highly likely to make a contract and a product category of the recommended merchandise to the sales representatives.

Furthermore, the prediction unit 15b can use collaborative filtering to specify a product to recommend to customers. Here, the collaborative filtering is a technique in which information of a target user and other users who have similar purchase histories is used, for example, to present the target user with a product that the target user has not purchased yet but other users have purchased.

The prediction unit 15b counts the contract-win data 14d, for example, for each customer and each product. Also, the prediction unit 15b counts the number of purchases of each product for each product category and vectorizes the purchase history of each customer. For example, the prediction unit 15b performs vectorization, such as [telephone system merchandise, Internet system merchandise, security system merchandise]=[10, 2, 0].

In addition, the prediction unit 15b calculates a degree of similarity of a purchase history for each customer based on a degree of cosine similarity expressed by the following formula (5).

$$\begin{matrix}[ Math . 5 ] & \\ cos ( x 1 , x 2 ) = \frac{x 1 \cdot x 2}{‖ x 1 ‖ \cdot \vert \vert x 2 ‖} & ( 5 )\end{matrix}$$

Then, the prediction unit 15b can specify, as a product to recommend, a product that a target customer has not purchased but another customer having a high degree of similarity in the purchase history to the target customer has purchased.

Note that, as shown in formula (3) above, the linear algorithm is expressed as a weighted linear sum of each explanatory variable. As the absolute value of the weight wᵢ becomes higher, the explanatory variable xᵢ has a greater effect on the output. The weight can be either positive or negative.

Thus, if the weight has a positive value and the absolute value of the weight is greater than another weight having a positive value, it greatly contributes to the prediction result “contract winnable”. In addition, if the weight has a negative value and the absolute value of the weight is greater than another weight having a negative value, it greatly contributes to the prediction result “contract not winnable”.

In addition, as the absolute value of the weight of the explanatory variable x becomes higher, it has a greater effect on the output. Thus, if the weight of the explanatory variable x has a positive value and the absolute value of the weight of the explanatory variable x is greater than another weight having a positive value, it greatly contributes to the prediction result “contract winnable”. In addition, if the weight of the explanatory variable x has a negative value and the absolute value of the weight of the explanatory variable x is greater than another weight having a negative value, it greatly contributes to the prediction result “contract not winnable”.

Thus, the contract-win prediction apparatus 10 can present a reason for the recommendation, for example, when presenting a customer who is highly likely to make a contract and the product category of the recommended merchandise to the sales representative. For example, the contract-win prediction apparatus 10 can use an explanatory variable (feature value data item) with a large contribution to present a past purchase of the product of the product category, a corporate size, or the like as a reason for the recommendation.

Note that the specification of the explanatory variable that greatly contributes to the prediction result “contract not winnable” is not limited to a case in which a linear algorithm is applied. For example, when the contract-win prediction model 14a is learned using the training data (X, y), the contract-win prediction apparatus 10 fixes the value of each explanatory variable of the feature value data X to any value or removes the explanatory variable, and thus can know the impact of the explanatory variable on the prediction result.

For example, in a case in which the explanatory variable has a binary value of 0 or 1, the contract-win prediction apparatus 10 can know a degree of impact of the value of the explanatory variable by changing the value to 0 or 1 only.

Alternatively, in a case in which explanatory variables are consecutively generated as in a case of following a Gaussian distribution, or the like, the contract-win prediction apparatus 10 can know a degree of impact of the value of an explanatory variable in accordance with a percentile of the distribution by fixing the value of the explanatory variable to any value such as an average value, a minimum value, or a maximum value.

Alternatively, the contract-win prediction apparatus 10 can know a degree of impact of an explanatory variable by removing any explanatory variable from the feature value data X and learning the contract-win prediction model 14a, and comparing a difference in prediction accuracy between the contract-win prediction models 14a before and after the removal. In this case, the number of variables to be removed can be specified as any value that is equal to or greater than 1 and smaller than or equal to [the number of explanatory variables]−1.

The list creation unit 15c creates a customer visit list including at least any of a contract-win probability, recommended merchandise, and a recommendation reason for each customer. For example, the list creation unit 15c creates the customer visit list using the contract-win probability and prediction results “contract winnable” and “contract not winnable” of a product of a predetermined product category for each sales representative and customer obtained from the prediction unit 15b. The list creation unit 15c presents the created customer visit list to the sales representative via the output unit 12 or the communication control unit 13.

Here, FIG. 7 is a diagram illustrating a customer visit list. In the example illustrated in FIG. 7, the customer visit list presented to each sales representative includes customer names, contract-win probabilities, recommended merchandise, and reasons for recommendation. As recommended merchandise, a product category that is predicted as “contract winnable” or a specified product is presented. In addition, as a recommendation reason, a recommendation reason using an explanatory variable with a high degree of impact on the prediction result is presented.

Contract-Win Prediction Processing

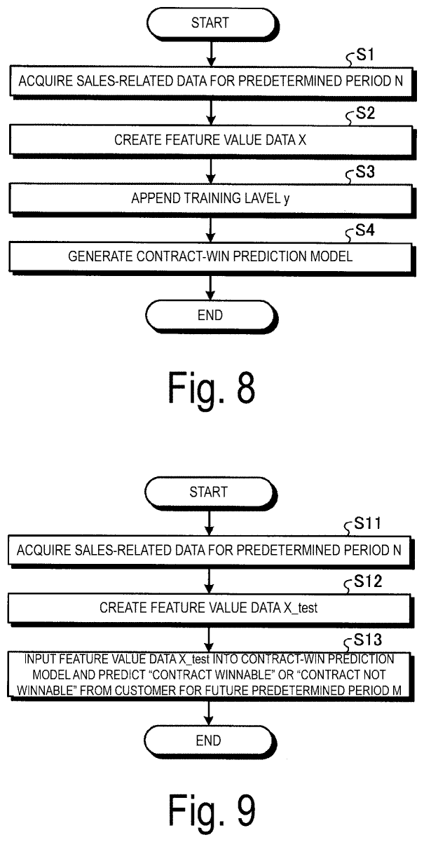

Next, contract-win prediction processing executed by the contract-win prediction apparatus 10 according to the present embodiment will be described with reference to FIGS. 8 and 9. FIG. 8 is a flowchart showing a contract-win prediction processing procedure by the generation unit 15a. The flowchart of FIG. 8 starts, for example, at a timing at which a user inputs an operation to instruct a start.

First, the generation unit 15a acquires, as sales-related data for the past predetermined period N, the sales representative data 14b, the customer data 14c, the contract-win data 14d, the daily report data 14e, or the corporate classification data 14f from the storage unit 14 (step S1).

Furthermore, the generation unit 15a creates the feature value data X using the sales-related data (step S2). Specifically, the generation unit 15a performs pre-processing to extract feature values of the sales-related data. At this time, the generation unit 15a extracts feature values of sales representatives, feature values of customers, and feature values of business types as feature values. In addition, the generation unit 15a aggregates the extracted feature values of the sales representatives, feature values of the customers, and feature values of the business types, creates tabular data with a feature value for each customer of each sales representative in one row, and sets the data as the feature value data X.

In addition, the generation unit 15a appends the training label y to the feature value data X (step S3). Specifically, the generation unit 15a uses sales-related data for the predetermined period M after the predetermined period N, which is a period during which the sales-related data that is the extraction source of the feature value data X was generated to append, as a training label y, a contract-win flag indicating whether a contract is won from a customer in the predetermined period M to the feature value data X.

In addition, the generation unit 15a uses the training data (X, y) to generate the contract-win prediction model 14a by learning (step S4). The generation unit 15a causes the storage unit 14 to store the generated contract-win prediction model 14a.

In addition, FIG. 9 is a flowchart showing a contract-win prediction processing procedure by the prediction unit 15b. The flowchart of FIG. 9 starts, for example, at a timing at which a sales representative inputs an operation to instruct a start.

First, the prediction unit 15b acquires, from the storage unit 14, the sales-related data for the predetermined period N different from the sales-related data used as the training data (step S11). The prediction unit 15b acquires, as the sales-related data, the sales representative data 14b, the customer data 14c, the contract-win data 14d, the daily report data 14e, or the corporate classification data 14f from the storage unit 14.

In addition, the prediction unit 15b uses the sales-related data to create the feature value data X_test (step S12). Specifically, the prediction unit 15b performs pre-processing to extract feature values of the sales-related data. At this time, the prediction unit 15b extracts feature values of sales representatives, feature values of customers, and feature values of business types as feature values.

In addition, the prediction unit 15b aggregates the extracted feature values of the sales representatives, feature values of the customers, and feature values of the business types, creates tabular data with a feature value for each customer of each sales representative in one row, and sets the data as the feature value data X_test. In addition, the prediction unit 15b performs a one-hot vector conversion on the feature value data X_test for standardization, and sets the result as feature value data X′_test.

Then, the prediction unit 15b inputs the feature value data X′_test into the contract-win prediction model 14a stored in the storage unit 14, and obtains a contract-win probability of a product of any product category of a customer with respect to a sales representative. Also, the prediction unit 15b obtains a prediction result y_test “contract winnable” or “contract not winnable” of the product of the product category from the customer for a future predetermined period M with respect to the sales representative for which the contract-win probability is classified at a predetermined threshold (step S13).

In addition, the list creation unit 15c uses the prediction result of the prediction unit 15b to create and present a customer visit list including contract-win probabilities, recommended merchandise, recommendation reasons, and the like for each customer to the sales representative. Thereby, the series of contract-win prediction processing ends.

### Example

It was found that, while the contract win percentage of sales representatives was approximately 10% in the past, the contract-win prediction apparatus 10 according to the present embodiment raised the percentage to 20.6% due to sales activities using prediction results provided by the apparatus, and thus achieved an improvement by 10%.

As described above, in the contract-win prediction apparatus 10 according to the present embodiment, the generation unit 15a uses, as training data, the sales-related data for the past predetermined period N and information indicating the presence or absence of a contract won from a customer for the predetermined period M after the predetermined period N, and generates, by learning, the contract-win prediction model 14a that receives an input of sales-related data for the predetermined period N of any customer and outputs a prediction result “contract winnable” or “contract not winnable” from the customer for the predetermined period M after the predetermined period N of the sales-related data. Further, by receiving the input of the sales-related data for the predetermined period N into the generated contract-win prediction model 14a, the prediction unit 15b predicts “contract winnable” or “contract not winnable” from the customer for the future predetermined period M.

Thus, the contract-win prediction apparatus 10 presents, to a sales representative, customers who contributed to the sales performance in the past and are highly likely to make a contract for a product of the product category that the sales representative is specialized. Therefore, the sales representative can select, for example, a customer who is congenial to him or her from among a number of customers to perform sales activities, and thus can efficiently increase sales performance in a short period. As described above, the contract-win prediction apparatus 10 makes it possible to conduct sales activities with high efficiency in consideration of sales representatives and customers.

Program

It is also possible to create a program in which processing executed by the contract-win prediction apparatus 10 according to the embodiment described above is described in a computer-executable language. As an embodiment, the contract-win prediction apparatus 10 can be implemented by installing a contract-win prediction program for executing the contract-win prediction processing as packaged software or online software in a desired computer. For example, by causing an information processing apparatus to execute the contract-win prediction program, the information processing apparatus can function as the contract-win prediction apparatus 10. The information processing apparatus referred here includes a desktop or notebook-type personal computer. Furthermore, on top of that, a mobile communication terminal such as a smart phone, a mobile phone, or a personal handyphone system (PHS), or a slate terminal such as a personal digital assistant (PDA), for example, is included in the category of the information processing apparatus. In addition, the functions of the contract-win prediction apparatus 10 may be implemented by a cloud server.

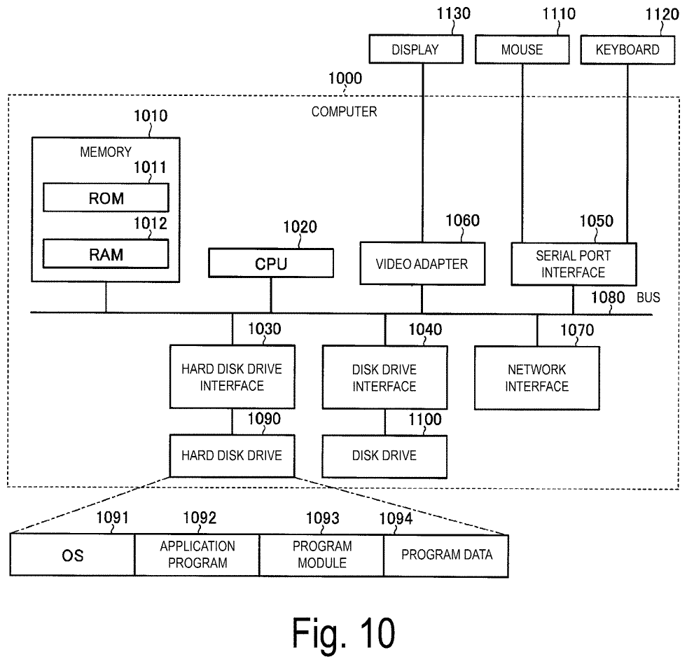

FIG. 10 is a diagram illustrating an example of a computer that executes a contract-win prediction program. A computer 1000 includes, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to the hard disk drive 1031. The disk drive interface 1040 is connected to a disk drive 1041. A detachable storage medium such as a magnetic disk or an optical disc, for example, is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. The respective pieces of information described in the aforementioned embodiment are stored in, for example, the hard disk drive 1031 and the memory 1010.

Further, the contract-win prediction program is stored in, for example, the hard disk drive 1031 as the program module 1093 in which instructions to be executed by the computer 1000 are described. Specifically, the program module 1093 in which each piece of processing to be executed by the contract-win prediction apparatus 10 described in the aforementioned embodiment is described is stored in the hard disk drive 1031.

In addition, data to be used in information processing according to the contract-win prediction program is stored as the program data 1094, for example, in the hard disk drive 1031. Then, the CPU 1020 reads the program module 1093 or the program data 1094 stored in the hard disk drive 1031 into the RAM 1012 as needed and executes each of the aforementioned procedures.

Note that the program module 1093 or the program data 1094 related to the contract-win prediction program is not limited to being stored in the hard disk drive 1031, and may be stored in, for example, a detachable storage medium and read by the CPU 1020 via the disk drive 1041 or the like. Alternatively, the program module 1093 or the program data 1094 related to the contract-win prediction program may be stored in another computer connected via a network such as a LAN or a wide area network (WAN) and read by the CPU 1020 via the network interface 1070.

Although the embodiment to which the invention made by the present inventors is applied have been described above, the present invention is not limited by the description and the drawings constituting a part of the disclosure of the present invention according to the embodiment. In other words, all of other embodiments, examples, operation technologies, and the like made by those skilled in the art based on the present embodiment fall within the scope of the present invention.

### REFERENCE SIGNS LIST

10 Contract-win prediction apparatus
11 Input unit
12 Output unit
13 Communication control unit
14 Storage unit
14a Contract-win prediction model
14b Sales representative data
14c Customer data
14d Contract-win data
14e Daily report Data
14f Corporate classification data
15 Control unit
15a Generation unit
15b Prediction unit
15c List creation unit

1. A contract-win prediction model generation method comprising:
acquiring sales-related data for a past predetermined period as training data; and
generating, by using the training data, a contract-win prediction model which receives an input of sales-related data for a predetermined period and outputs a contract-win probability with respect to a customer for a predetermined period after the aforementioned predetermined period.

2. A contract-win prediction model for functioning a computer to:
learn a parameter of the contract-win prediction model by machine learning by using, as training data, sales-related data for a past predetermined period and information indicating the presence or absence of a contract won from a customer for a predetermined period after the aforementioned predetermined period,
receive an input of sales-related data of any customer for a predetermined period, and
output a prediction result “contract winnable” or “contract not winnable” from the customer for a predetermined period after the aforementioned predetermined period of the sales-related data.

3. The contract-win prediction model according to claim 2,
wherein sales representative data, customer data, contract-win data, daily report data, and corporate classification data are input as the sales-related data.

4. The contract-win prediction model according to claim 2,
wherein data obtained by pre-processing the sales-related data to extract a feature value of a sales representative, a feature value of a customer, and a feature value of a business type is input.

5. The contract-win prediction model according to claim 4,
wherein data obtained by pre-processing to perform a one-hot vector conversion and standardization on the feature values is further input.

6. The contract-win prediction model according to claim 2,
wherein the contract-win prediction model has a parameter to be learned according to a logistic regression algorithm.

7. A contract-win prediction apparatus comprising:
generation circuitry configured to use, as training data, sales-related data for a past predetermined period and information indicating the presence or absence of a contract won from a customer for a predetermined period after the aforementioned predetermined period and to generate, by learning, a contract-win prediction model that receives an input of sales-related data of any customer for a predetermined period and outputs a prediction result “contract winnable” or “contract not winnable” from the customer for a predetermined period after the aforementioned predetermined period of the sales-related data; and
prediction circuitry configured to predict “contract winnable” or “contract not winnable” from a customer for a future predetermined period with an input of sales-related data for a predetermined period into the generated contract-win prediction model.

8. The contract-win prediction apparatus according to claim 7,
wherein the prediction circuitry further identifies a product to recommend to the customer using collaborative filtering.

9. The contract-win prediction apparatus according to claim 7,
wherein the prediction circuitry identifies a product category of a product to recommended to the customer using a multi-label classification algorithm.

10. The contract-win prediction apparatus according to claim 7, further comprising:
list creation circuitry configured to create, for a customer, a customer visit list including at least one of a contract-win probability, recommended merchandise, and a recommendation reason.

11. A contract-win prediction method executed by a contract-win prediction apparatus, the method comprising:
generating, by learning, a contract-win prediction model by using, as training data, sales-related data for a past predetermined period and information indicating the presence or absence of a contract won from a customer for a predetermined period after the aforementioned predetermined period, the contract-win prediction model configured to receive an input of sales-related data of any customer for the aforementioned predetermined period and to output a prediction result “contract winnable” or “contract not winnable” from the customer for a predetermined period after the aforementioned predetermined period of the sales-related data; and
predicting “contract winnable” or “contract not winnable” from a customer for a future predetermined period with an input of sales-related data for a predetermined period into the generated contract-win prediction model.

12. A non-transitory computer readable medium storing a contract-win prediction program for causing a computer to:
generate, by learning, a contract-win prediction model by using, as training data, sales-related data for a past predetermined period and information indicating the presence or absence of a contract won from a customer for a predetermined period after the aforementioned predetermined period, the contract-win prediction model configured to receive an input of sales-related data of any customer for a predetermined period, and to output a prediction result “contract winnable” or “contract not winnable” from the customer for the predetermined period after the aforementioned predetermined period of the sales-related data; and
predict “contract winnable” or “contract not winnable” from a customer for a future predetermined period with an input of sales-related data for a aforementioned predetermined period into the generated contract-win prediction model.
